(19) United States
(12) Patent Application Publication
(10) Pub. No.: US 2026/0319743 A1
(43) Pub. Date: Oct. 15, 2026

(54) PROCESSING-IN-MEMORY SYSTEM WITH EXPANDED ADDRESS SPACE

(71) Applicant: SK hynix Inc., Icheon-si Gyeonggi-do (KR)

(72) Inventor: Il Kon KIM, Icheon-si Gyeonggi-do (KR)

(73) Assignee: SK hynix Inc., Icheon-si Gyeonggi-do (KR)

(21) Appl. No.: 19/258,354

(22) Filed: Jul. 2, 2025

(30) Foreign Application Priority Data
Apr. 14, 2025 (KR) 10-2025-0048438

(51) Int. Cl. G06F 7/544; G06F 7/487; G06F 12/02; G06F 12/0882

(52) U.S. Cl. CPC G06F 7/5443; G06F 7/4876; G06F 12/0246; G06F 12/0882

(57) ABSTRACT

A processing-in-memory (PIM) system includes a memory management unit configured to convert a virtual address into a physical address and output the physical address, a memory controller configured to output either a first physical address in a first physical address space or a second physical address in a second physical address space based on the physical address received from the memory management unit, and a PIM device configured to perform a memory operation when the first physical address is received from the memory controller and to perform a computation operation when the second physical address is received from the memory controller.

### CROSS-REFERENCE TO RELATED APPLICATION

The present application claims priority under 35 U.S.C. § 119(a) to Korean Application No. 10-2025-0048438, filed in the Korean Intellectual Property Office on Apr. 14, 2025, the entire contents of which application is incorporated herein by reference.

### BACKGROUND

### 1. Technical Field

Various embodiments of the present teachings relate to a processing-in-memory (PIM) system, and more particularly, to a PIM system with expanded address space.

### 2. Related Art

PIM devices are devices that perform data processing, either within memory or in close proximity to memory. PIM devices are advantageous in that they can reduce the time and energy consumption associated with data movement between a host and the memory or between a memory controller and the memory. To achieve this, PIM devices are configured such that memory circuits and computation circuits are disposed adjacent to each other. The data stored in the memory circuit of a PIM device may be data for memory operations or data for computation operations. However, since the characteristics of memory operations differ from those of computation operations, the data for memory operations and the data for computation operations may be written to the memory circuit according to different address mapping sequences. Accordingly, there is a need for the development of a PIM system that is capable of applying both an address mapping sequence suitable for computation operations and an address mapping sequence suitable for memory operations.

### SUMMARY

A processing-in-memory (PIM) system according to an embodiment of the present disclosure may include a memory management unit configured to convert a virtual address into a physical address and output the physical address, a memory controller configured to output either a first physical address in a first physical address space or a second physical address in a second physical address space based on the physical address received from the memory management unit, and a PIM device configured to perform a memory operation when the first physical address is received from the memory controller and to perform a computation operation when the second physical address is received from the memory controller.

### BRIEF DESCRIPTION OF THE DRAWINGS

FIG. 1 is a block diagram illustrating an example of a PIM system according to an embodiment of the present disclosure.

FIG. 2 is a block diagram illustrating an example of a PIM device included in the PIM system of FIG. 1.

FIG. 3 is a block diagram illustrating an example of a processing element included in the PIM device of FIG. 2.

FIG. 4 is a diagram illustrating an example configuration of a physical address space of a memory controller included in the PIM system of FIG. 1.

FIG. 5 is a diagram illustrating a data write operation based on a first command and a first physical address.

FIG. 6 is a diagram illustrating a data write operation based on a second command and a second physical address.

FIG. 7 is a block diagram illustrating another example of a PIM system according to an embodiment of the present disclosure.

### DETAILED DESCRIPTION

Terms such as “first” and “second” are used to distinguish between various elements and do not imply size, order, priority, quantity, or importance of the elements. For example, a first element may be referred to as a second element in one example, and the second element may be referred to as a first element in another example.

When an element is referred to as “connected” or “coupled” to another element, the elements may be connected directly or through one or more intervening elements between the elements. When two elements are referred to as “directly connected” or “directly coupled,” one element is directly connected or directly coupled to the other element without an intervening element between the two elements.

Terms such as “over,” “on,” “inside,” “higher,” “high,” “low,” “left,” “right,” “column,” “row,” “level,” and other terms implying relative spatial relationship or orientation are utilized only for the purpose of ease of description or reference to a drawing and are not otherwise limiting.

Embodiments of the present disclosure are described in detail with reference to the accompanying drawings. Specific structural or functional descriptions of embodiments are provided as examples for illustrative purposes to describe concepts that are disclosed in the present application. Examples or embodiments in accordance with the concepts may be carried out in various forms, and the scope of the present disclosure is not limited to the examples or embodiments described in this specification.

It should be understood that the various embodiments described below refer to DRAM as an example; however, the disclosure is not limited thereto. For example, the same may be applied to static random access memory (SRAM), synchronous DRAM (SDRAM), double data rate synchronous DRAM (DDR SDRAM, DDR2 SDRAM, DDR3 SDRAM, etc.), graphics double data rate synchronous DRAM (GDDR, GDDR2, GDDR3, etc.), quad data rate DRAM (QDR DRAM), RAMBUS XDR DRAM (XDR DRAM), fast page mode DRAM (FPM DRAM), video DRAM (VDRAM), extended data output DRAM (EDO DRAM), burst EDO DRAM (BEDO DRAM), multibank DRAM (MDRAM), synchronous graphics RAM (SGRAM), and/or other various forms of DRAM.

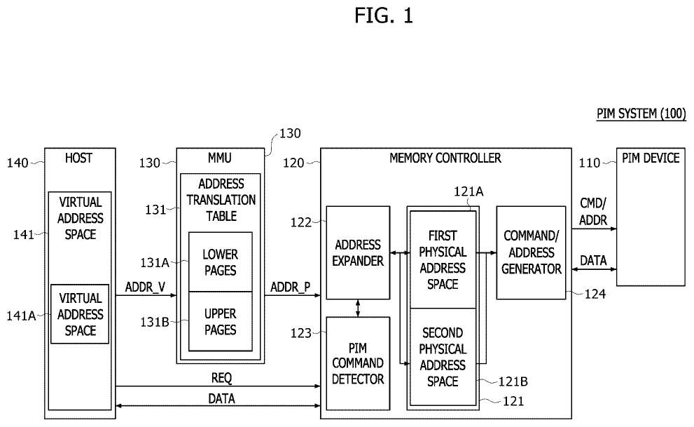

FIG. 1 is a block diagram illustrating an example of a PIM system according to an embodiment of the present disclosure.

Referring to FIG. 1, a PIM system 100 may include a PIM device 110, a memory controller 120, a memory management unit (MMU) 130, and a host 140. The PIM device 110 is coupled to the memory controller 120. Accordingly, the PIM device 110 may receive a command CMD and an address ADDR from the memory controller 120. The PIM device 110 may also either receive data DATA from the memory controller 120 or transmit data DATA to the memory controller 120. In one embodiment, the PIM device 110 may be implemented such that a memory circuit and a processing element are integrated on a single chip.

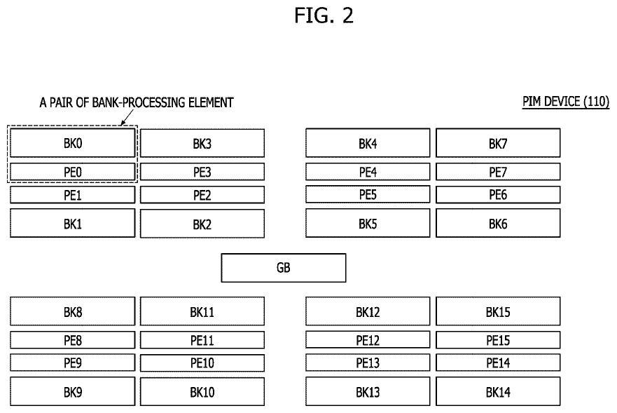

The memory circuit of the PIM device 110 may be a non-volatile memory circuit, such as a flash memory circuit, or a volatile memory circuit, such as a dynamic random access memory (DRAM) or a static random access memory (SRAM). In the following description, as one example, it is assumed that the memory circuit of the PIM device 110 is a DRAM. In another embodiment, the PIM device 110 may be an Analog-Computing-in-Memory (A-CiM) device that directly performs computations by using analog signals, such as voltages and currents, in the memory cells. In such a case, the memory cell may be a static random access memory (SRAM) cell, a resistive random access memory (ReRAM) cell, a phase change memory (PCM) cell, a magnetoresistive random access memory (MRAM) cell, or a flash memory cell. A more detailed description of the PIM device 110 employing DRAM as the memory circuit will now be provided with reference to FIG. 2 below.

The memory controller 120 is coupled to the PIM device 110, the memory management unit 130, and the host 140. The memory controller 120 may receive a physical address ADDR_P from the memory management unit 130. The memory controller 120 may receive data DATA to be written to the PIM device 110 from the host 140 or may transmit data DATA read from the PIM device 110 to the host 140. The memory controller 120 may receive a request REQ from the host 140. Based on the request REQ transmitted from the host 140, the memory controller 120 may generate a command CMD and may transmit the command to the PIM device 110.

In one embodiment, the memory controller 120 may include a physical address space 121, an address expander 122, a PIM command detector 123, and a command/address generator 124. The physical address space 121 may include a first physical address space 121A and a second physical address space 121B. Based on the physical address ADDR_P received from the memory management unit 130, the memory controller 120 may output a first physical address from the first physical address space 121A or a second physical address from the second physical address space 121B to the PIM device 110.

The first physical address space 121A and the second physical address space 121B each represent an address range that is available in the memory circuit included in the PIM device 110. The address range of the first physical address space 121A is identical to that of the second physical address space 121B. A first address mapping layout may be applied to the first physical address space 121A, and a second address mapping layout may be applied to the second physical address space 121B. In one embodiment, the first address mapping layout may use a row-bank-column mapping order, whereas the second address mapping layout may use a row-column-bank mapping order.

The address expander 122 extends the first physical address space 121A to generate the second physical address space 121B such that the physical address space 121 includes both the first physical address space 121A and the second physical address space 121B. The address expander 122 may receive a physical address ADDR_P from the memory management unit 130. The address expander 122 may also receive a first control signal or a second control signal from the PIM command detector 123. In one embodiment, when the first control signal is received from the PIM command detector 123, the address expander 122 transfers the physical address ADDR_P received from the memory management unit 130 to the first physical address space 121A. When the second control signal is received from the PIM command detector 123, the address expander 122 transfers the physical address ADDR_P received from the memory management unit 130 to the second physical address space 121B.

The PIM command detector 123 may receive a physical address (ADDR_P) transmitted from the memory management unit 130. The PIM command detector 123 may receive the physical address ADDR_P directly from the memory management unit 130 or via the address expander 122. In one embodiment, when the physical address ADDR_P transmitted from the memory management unit 130 is included in the first physical address space 121A, the PIM command detector 123 may generate a first control signal and may transmit the first control signal to the address expander 122. On the other hand, when the physical address ADDR_P transmitted from the memory management unit 130 is included in the second physical address space 121B, the PIM command detector 123 may generate a second control signal and transmit the second control signal to the address expander 122. In one embodiment, when specific bits of the physical address ADDR_P transmitted from the memory management unit 130, such as the upper bits, have a first value, the PIM command detector 123 generates the first control signal. Conversely, when the specific bits, such as the upper bits, have a second value, the PIM command detector 123 generates the second control signal.

The command/address generator 124 generates a command based on a request REQ transmitted from the host 140 and transmits the command to the PIM device 110. In one embodiment, the command may be either a memory command or a computation command. The memory command may specify a read operation or a write operation for the memory circuit included in the PIM device 110. The computation command may specify a computation operation to be performed by a computation circuit included in the PIM device 110. The computation command may also specify a write operation for writing data, which is to be used in a computation operation, to the memory circuit included in the PIM device 110. When a first physical address is transmitted from the first physical address space 121A, the command/address generator 124 transmits the first physical address along with the command to the PIM device 110. When a second physical address is transmitted from the second physical address space 121B, the command/address generator 124 transmits the second physical address along with the command to the PIM device 110.

The memory management unit 130 converts a virtual address ADDR_V, transmitted from the host 140, into a physical address ADDR_P and outputs the physical address ADDR_P. In one embodiment, the process of converting the virtual address ADDR_V into the physical address ADDR_P may be performed using a paging technique. To this end, the memory management unit 130 may include an address translation table 131. When a virtual address ADDR_V is transmitted from the host 140, the memory management unit 130 may perform an address translation by referring to the address translation table 131 to identify a frame number corresponding to the virtual address ADDR_V, which corresponds to a part of the physical address ADDR_P. During such an address translation process, the memory management unit 130 may utilize a Translation Lookaside Buffer (TLB) to store mappings between frequently used virtual addresses ADDR_V and physical addresses ADDR_P. In one embodiment, the address translation table 131 included in the memory management unit 130 may include lower pages 131A and upper pages 131B. In one example, the lower pages 131A and the upper pages 131B may be generated by allocating double the number of pages in the address translation table 131.

The host 140 may include a software domain comprising a process (or program) designated by a user, and an operating system (OS). The host 140 may include a virtual address space 141. The virtual address space 141 may be independently allocated for each process. The operating system may provide the virtual address space 141 for the process. The virtual address space 141 may include a virtual address allocator 141A. The virtual address allocator 141A allocates a virtual address ADDR_V such that it distinguishes whether the virtual address is associated with a memory operation or a computation operation for the PIM device 110. In one embodiment, when the host 140 outputs a request REQ for a memory operation of the PIM device 110, the host 140 transmits a virtual address ADDR_V in which specific bits, such as the upper bits, have a first binary value to the memory management unit 130. In contrast, when the host 140 outputs a request REQ for a computation operation of the PIM device 110, the host 140 transmits a virtual address ADDR_V in which the specific bits, such as the upper bits, have a second binary value to the memory management unit 130.

FIG. 2 is a block diagram illustrating an example of a PIM device included in the PIM system of FIG. 1.

Referring to FIG. 2, the PIM device 110 may include a plurality of memory banks, such as first through sixteenth memory banks BK0-BK15, a global buffer GB, and a plurality of processing elements, such as first through sixteenth processing elements PE0-PE15. In one example, the memory banks BK0 to BK15 may each be a memory array or a collection of memory arrays that constitute a dynamic random access memory (DRAM). Accordingly, the memory banks BK0 to BK15 may operate independently of one another. Each of the memory banks BK0 to BK15 may be designated by a bank address. Each of the memory banks BK0 to BK15 may include a plurality of rows and a plurality of columns. Each of the plurality of rows may be designated by a row address, and each of the plurality of columns may be designated by a column address.

The global buffer GB may include a plurality of storage regions, such as a plurality of registers. In one embodiment, each of the storage regions of the global buffer GB may be designated by a column address. That is, a specific column in one of the memory banks BK0 to BK15 may be designated by a column address, and a specific storage region in the global buffer GB may also be designated by the column address. In another embodiment, each of the storage regions of the global buffer GB may be designated by a register index that specifies a particular storage location within a register. In one embodiment, the global buffer GB may store vector data that is used as an operand in a matrix-vector multiplication operation.

The first through sixteenth processing elements PE0-PE15 are respectively coupled to the first through sixteenth memory banks BK0-BK15. For example, the first processing element PE0 is coupled to the first memory bank BK0, and the second processing element PE1 is coupled to the second memory bank BK1. Similarly, the sixteenth processing element PE15 is coupled to the sixteenth memory bank BK15. All of the first through sixteenth processing elements PE0-PE15 are commonly coupled to the global buffer GB. The processing elements PE0 through PE15 may respectively receive first operand data, such as sets of weight data, from the memory banks BK0 through BK15. For example, the first processing element PE0 may receive a first set of weight data from the first memory bank BK0. The second processing element PE1 may receive a second set of weight data from the second memory bank BK1. Likewise, the sixteenth processing element PE15 may receive a sixteenth set of weight data from the sixteenth memory bank BK15. The processing elements PE0 through PE15 may also commonly receive second operand data, such as vector data, from the global buffer GB. Using the respective sets of weight data received from the memory banks BK0 through BK15 and the vector data received from the global buffer GB, the processing elements PE0 through PE15 may perform computation operations, such as multiplication-accumulation (MAC) operations.

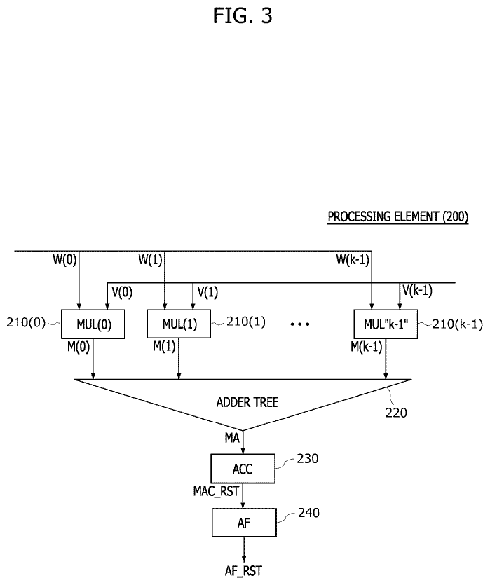

In the present example, the PIM device 110 is described as including an equal number of memory banks BK0-BK15 and processing elements PE0-PE15. However, this is merely one example. In other embodiments, the PIM device 110 may include a different number of memory banks and processing elements. For instance, the PIM device 110 may have a configuration in which two memory banks share a single processing element. In this case, the number of processing elements may be half the number of memory banks. The PIM device 110 may also have a configuration in which four memory banks share a single processing element. In this case, the number of processing elements may be one-fourth the number of memory banks.
FIG. 3 is a block diagram illustrating an example of a processing element included in the PIM device of FIG. 2.

Referring to FIG. 3, the processing element 200 may include a multiplication circuit, an addition circuit, an accumulator (ACC) 230, and an activation function circuit (AF) 240. The multiplication circuit may include first through k-th multipliers (MUL(0)-MUL(k−1)) 210(0)-210(k−1). Here, k is a natural number equal to or greater than 2. The addition circuit may be configured as an adder tree 220, which includes a plurality of adders. The description of the processing element 200 provided herein may be commonly applicable to the first through sixteenth processing elements PE0-PE15 shown in FIG. 2.

The first through k-th multipliers 210(0)-210(k−1) respectively receive first through k-th weight data W(0)-W(k−1) from the memory bank. The first through k-th multipliers 210(0)-210(k−1) also respectively receive first through k-th vector data V(0)-V(k−1) from the global buffer. The first through k-th multipliers 210(0)-210(k−1) respectively perform multiplication operations on the corresponding weight data W(0)-W(k−1) and vector data V(0)-V(k−1), and output first through k-th multiplication results M(0)-M(k−1), respectively. Specifically, the first multiplier 210(0) performs a multiplication operation on the first weight data W(0) and the first vector data V(0) and outputs the first multiplication result M(0). The second multiplier 210(1) performs a multiplication operation on the second weight data W(1) and the second vector data V(1) and outputs the second multiplication result M(1). Likewise, the k-th multiplier 210(k−1) performs a multiplication operation on the k-th weight data W(k−1) and the k-th vector data V(k−1) and outputs the k-th multiplication result M(k−1).

The adder tree 220 receives the first through k-th multiplication results M(0)-M(k−1) from the first through k-th multipliers 210(0)-210(k−1). The adder tree 220 performs an addition operation on the multiplication results M(0)-M(k−1). The adder tree 220 outputs the result of the addition operation as multiplication-accumulation data MA. Although not explicitly shown in FIG. 3, the adder tree 220 may include a plurality of adders arranged in a tree structure. The adder tree 220 transmits the multiplication-accumulation data MA to the accumulator 230.

The accumulator 230 may include an accumulation adder and a latch circuit. The accumulation adder performs an accumulation operation by adding the multiplication-accumulation data MA received from the adder tree 220 with latch data fed back from the latch circuit, thereby generating accumulated addition data. The latch circuit latches the accumulated addition data generated by the accumulation adder. The accumulated addition data latched in the latch circuit is fed back to the accumulation adder as latch data during the subsequent MAC operation cycle. When all MAC operations are completed, the latch circuit outputs the latched accumulated addition data as MAC result data MAC_RST.

The activation function circuit 240 may receive the MAC result data MAC_RST from the accumulator 230. The activation function circuit 240 may perform activation function processing on the MAC result data and output activation-function-processed result data AF_RST. Through the activation function processing, the output result data AF_RST may acquire nonlinearity. In one embodiment, the activation function processing may be performed using a sigmoid function, a hyperbolic tangent function, a ReLU (Rectified Linear Unit) function, a leaky ReLU function, a swish function, or the like.

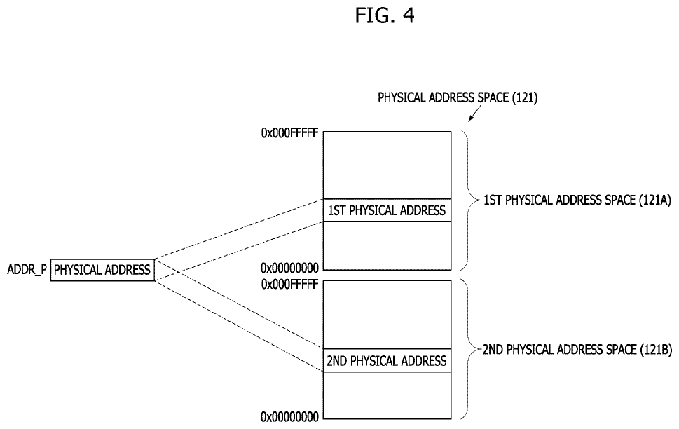

FIG. 4 is a diagram illustrating an example configuration of a physical address space of a memory controller included in the PIM system of FIG. 1.

Referring to FIG. 4, the physical address space 121 includes a first physical address space 121A and a second physical address space 121B. The second physical address space 121B may be generated by extending the first physical address space 121A. Accordingly, the second physical address space 121B has the same address region as the first physical address space 121A. In one example, as shown in FIG. 4, if the first physical address space 121A spans the address range from “0×00000000” to “0×000FFFFF,” then the second physical address space 121B also spans the same address range from “0×00000000” to “0×000FFFFF.”

In one embodiment, the first physical address space 121A may be mapped according to a first address mapping layout, and the second physical address space 121B may be mapped according to a second address mapping layout. The first address mapping layout may be suitable for memory operations performed by the PIM device 110, whereas the second address mapping layout may be suitable for computation operations performed by the PIM device 110. In one example, the first address mapping layout may follow a row-bank-column mapping order, and the second address mapping layout may follow a row-column-bank mapping order.

The physical address ADDR_P transmitted from the memory management unit 130 may be directed to either the first physical address space 121A or the second physical address space 121B. Specifically, when the physical address ADDR_P transmitted from the memory management unit 130 is included in the first physical address space 121A, the PIM command detector 123 of the memory controller 120 generates a first control signal and transmits the first control signal to the address expander 122. In contrast, when the physical address ADDR_P is included in the second physical address space 121B, the PIM command detector 123 generates a second control signal and transmits the second control signal to the address expander 122. Upon receiving the first control signal from the PIM command detector 123, the address expander 122 transfers the physical address ADDR_P to the first physical address space 121A. Upon receiving the second control signal, the address expander 122 transfers the physical address ADDR_P to the second physical address space 121B.

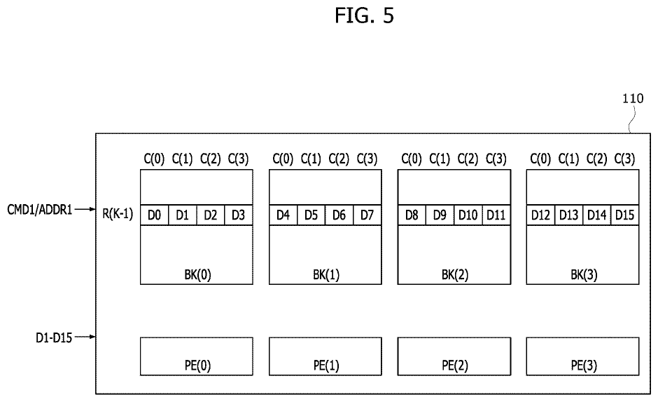

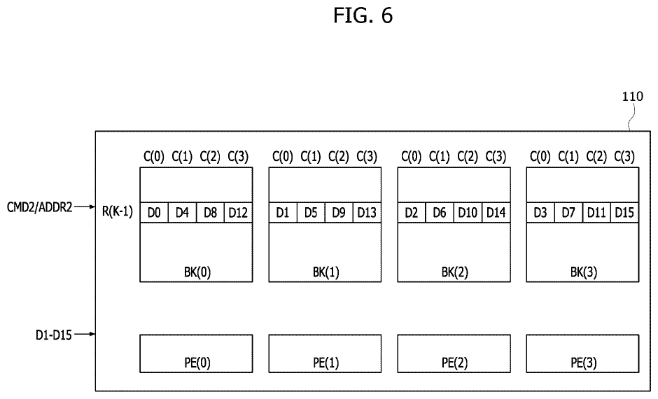

When the physical address ADDR_P is transferred from the address expander 122, the first physical address space 121A outputs a first physical address based on a first address mapping order. In contrast, when the physical address ADDR_P is transferred from the address expander 122, the second physical address space 121B outputs a second physical address based on a second address mapping order. The address in the first physical address space 121A corresponding to the first physical address and the address in the second physical address space 121B corresponding to the second physical address may be identical. However, due to the different address mapping orders, the regions of memory banks in the PIM device 110 specified by the first physical address may differ from the regions of memory banks in the PIM device 110 specified by the second physical address.
FIG. 5 is a diagram illustrating a data write operation based on a first command and a first physical address. FIG. 6 is a diagram illustrating a data write operation based on a second command and a second physical address. In the following description, it is assumed as an example that the PIM device includes four memory banks, i.e., first through fourth memory banks. It is also assumed that the first physical address follows a first address mapping order of row-bank-column, and the second physical address follows a second address mapping order of row-column-bank.

Referring to FIG. 5, when a first command CMD1 and a first physical address ADDR1, along with first through sixteenth data elements D0-D15, are transmitted to the PIM device 110, the first through fourth memory banks BK(0)-BK(3) of the PIM device 110 store the data D0-D15 in accordance with a first address mapping layout defined by the first physical address ADDR1. The data D0-D15 may be unrelated to any computation operation performed within the PIM device 110. The first command CMD1 may be a write command. It is assumed that the row address included in the first physical address ADDR1 designates a K-th row R(K−1), the bank address designates the first memory bank BK(0), and the column address designates the first column C(0).

Since the first address mapping order defined by the first physical address ADDR1 is row-bank-column, the data write operation is performed in such a manner that the column increases first among the bank, row, and column values of the memory banks BK(0)-BK(3), followed by an increment in the bank. Accordingly, the first through fourth data D0-D3 are sequentially stored in the first through fourth columns C(0)-C(3) of the K-th row R(K−1) in the first memory bank BK(0). Next, the fifth through eighth data D4-D7 are sequentially stored in the first through fourth columns C(0)-C(3) of the K-th row R(K−1) in the second memory bank BK(1). Subsequently, the ninth through twelfth data D8-D11 are sequentially stored in the first through fourth columns C(0)-C(3) of the K-th row R(K−1) in the third memory bank BK(2). Finally, the thirteenth through sixteenth data D12-D15 are sequentially stored in the first through fourth columns C(0)-C(3) of the K-th Row R(k−1) in the Fourth Memory Bank Bk(3).

Referring to FIG. 6, when a second command CMD2 and a second physical address ADDR2, along with first through sixteenth data elements D0-D15, are transmitted to the PIM device 110, the first through fourth memory banks BK(0)-BK(3) of the PIM device 110 store the data D0-D15 in accordance with a second address mapping layout defined by the second physical address ADDR2. The data D0-D15 may be operand data used in computation operations within the PIM device 110, such as weight data included in a weight matrix for matrix-vector multiplication operations. The second command CMD2 may be a write command. It is assumed that the row address included in the second physical address ADDR2 designates the K-th row R(K−1), the bank address designates the first memory bank BK(0), and the column address designates the

### First Column C(0).

Since the second address mapping order defined by the second physical address ADDR2 is row-column-bank, the data write operation is performed such that the bank increments first among the bank, row, and column values of the memory banks BK(0)-BK(3), followed by an increment in the column. Accordingly, the first through fourth data D0-D3 are respectively stored in the first columns C(0) of the K-th row R(K−1) in the memory banks BK(0) through BK(3). Next, the fifth through eighth data D4-D7 are respectively stored in the second columns C(1) of the K-th row R(K−1) in the memory banks BK(0) through BK(3). Subsequently, the ninth through twelfth data D8-D11 are respectively stored in the third columns C(2) of the K-th row R(K−1) in the memory banks BK(0) through BK(3). Finally, the thirteenth through sixteenth data D12-D15 are respectively stored in the fourth columns C(3) of the K-th row R(K−1) in the memory banks BK(0) through BK(3).

As a result, in the first memory bank BK(0), the first through fourth columns C(0)-C(3) of the K-th row R(K−1) respectively store the first data D0, fifth data D4, ninth data D8, and thirteenth data D12. In the second memory bank BK(1), the first through fourth columns C(0)-C(3) of the K-th row R(K−1) respectively store the second data D1, sixth data D5, tenth data D9, and fourteenth data D13. In the third memory bank BK(2), the first through fourth columns C(0)-C(3) of the K-th row R(K−1) respectively store the third data D2, seventh data D6, eleventh data D10, and fifteenth data D14. In the fourth memory bank BK(3), the first through fourth columns C(0)-C(3) of the K-th row R(K−1) respectively store the fourth data D3, eighth data D7, twelfth data D11, and sixteenth data D15.

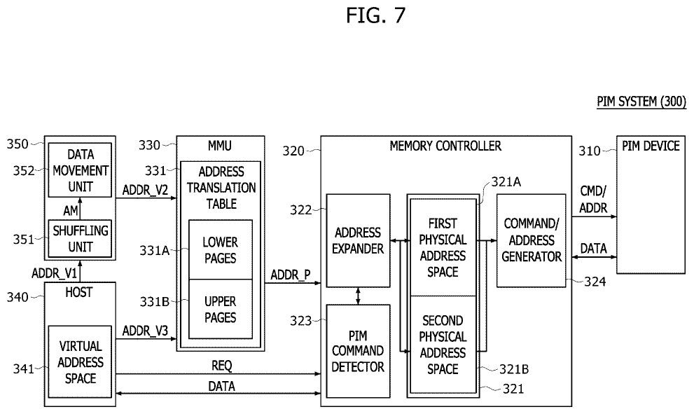

FIG. 7 is a block diagram illustrating another example of a PIM system according to an embodiment of the present disclosure.

Referring to FIG. 7, the PIM system 300 may include a PIM device 310, a memory controller 320, a memory management unit (MMU) 330, a host 340, and a direct memory access controller 350. The PIM device 310 included in the PIM system 300 may be configured identically to the PIM device 110 included in the PIM system 100 as described with reference to FIG. 1. Accordingly, the description of the PIM device 110 given with reference to FIG. 2, and the description of the processing element 200 given with reference to FIG. 3, may equally apply to the PIM device 310 included in the PIM system 300.

The memory controller 320 included in the PIM system 300 may also be configured identically to the memory controller 120 included in the PIM system 100 described with reference to FIG. 1. Accordingly, the memory controller 320 includes a physical address space 321 comprising a first physical address space 321A and a second physical address space 321B, an address expander 322, a PIM command detector 323, and a command/address generator 324. The memory management unit 330 included in the PIM system 300 may be configured similarly to the memory management unit 130 described with reference to FIG. 1. Accordingly, the memory management unit 330 includes an address translation table 331 comprising lower pages 331A and upper pages 331B.

The host 340 included in the PIM system 300 may include a virtual address space 341. The virtual address space 341 is configured such that virtual addresses ADDR_V are allocated depending on whether they are associated with memory operations or computation operations of the PIM device 310. In one example, the host 340 may transmit a first virtual address ADDR_V1, associated with a memory operation of the PIM device 310, to the direct memory access controller 350. In this case, the direct memory access controller 350 generates a second virtual address ADDR_V2, by modifying the address mapping order of the first virtual address ADDR_V1 and outputs the second virtual address ADDR_V2 to the memory management unit 330. Meanwhile, the host 340 may transmit a third virtual address ADDR_V3, associated with a computation operation of the PIM device 310, directly to the memory management unit 330.

When the second virtual address ADDR_V2 is transmitted, the memory management unit 330 outputs a physical address ADDR_P that is mapped to the second virtual address ADDR_V2, among the physical addresses included in the lower pages of the address translation table 331, and transmits the physical address ADDR_P to the memory controller 320. In one example, a specific bit of the physical address ADDR_P mapped to the second virtual address ADDR_V2, such as a higher-order bit, may have a first value. On the other hand, when the third virtual address ADDR_V3 is transmitted, the memory management unit 330 outputs a physical address ADDR_P that is mapped to the third virtual address ADDR_V3, among the physical addresses included in the upper pages of the address translation table 331, and transmits the physical address ADDR_P to the memory controller 320. In one example, a specific bit of the physical address ADDR_P mapped to the third virtual address ADDR_V3, such as a higher-order bit, may have a second value.

The direct memory access controller 350 included in the PIM system 300 may include a shuffling unit 351 and a data movement unit 352. When the first virtual address ADDR_V1 is transmitted from the host 340, the shuffling unit 351 generates and outputs an address mapping control signal AM that designates a first address mapping order, which is different from a second address mapping order, associated with the first virtual address ADDR_V1. The shuffling unit 351 transmits the address mapping control signal AM to the data movement unit 352. The data movement unit 352 reorders the address data constituting the first virtual address ADDR_V1 such that it conforms to the first address mapping order designated by the address mapping control signal AM, thereby generating a second virtual address ADDR_V2. The data movement unit 352 then transmits the second virtual address ADDR_V2, having the first address

### Mapping Order, to the Memory Management Unit 330.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A processing-in-memory (PIM) system comprising:
a memory management unit configured to convert a virtual address into a physical address and output the physical address;
a memory controller configured to output either a first physical address in a first physical address space or a second physical address in a second physical address space, based on the physical address transmitted from the memory management unit; and
a PIM device configured to perform a memory operation based on the first physical address and configured to perform a computation operation based on the second physical address.

2. The PIM system of claim 1,
wherein the PIM device comprises:
a plurality of first memory circuits configured to store first data used as a first operand;
a second memory circuit configured to store second data used as a second operand; and
a plurality of processing elements configured to perform a computation operation using the first data and the second data.

3. The PIM system of claim 2,
wherein the plurality of first memory circuits are memory banks, and
wherein the second memory circuit is a global buffer.

4. The PIM system of claim 2,
wherein each of the plurality of processing elements comprises:
a plurality of multiplication circuits configured to perform multiplication operations on the first data and the second data and configured to output multiplication result data;
an addition circuit configured to add the multiplication result data output from the plurality of multiplication circuits and to output multiplication/addition data; and
an accumulation circuit configured to accumulate the multiplication/addition data output from the addition circuit with latch data and to output accumulated data.

5. The PIM system of claim 1,
wherein the memory controller is configured to output the first physical address when a specific bit of the physical address has a first value and configured to output the second physical address when the specific bit of the physical address has a second value.

6. The PIM system of claim 1,
wherein the memory controller comprises:
a physical address space including the first physical address space and the second physical address space;
an address expander configured to extend the first physical address space such that the second physical address space is generated and included within the physical address space; and
a PIM command detector configured to generate a first control signal when the physical address is included in the first physical address space and configured to generate a second control signal when the physical address is included in the second physical address space.

7. The PIM system of claim 6,
wherein the first physical address space is associated with a first address mapping layout, and
wherein the second physical address space is associated with a second address mapping layout.

8. The PIM system of claim 7,
wherein the first address mapping layout has a row-bank-column address mapping order, and
wherein the second address mapping layout has a row-column-bank address mapping order.

9. The PIM system of claim 6,
wherein the address expander is configured to transmit the physical address to the first physical address space when the first control signal is received from the PIM command detector and configured to transmit the physical address to the second physical address space when the second control signal is received from the PIM command detector.

10. The PIM system of claim 9,
wherein the first physical address space is configured to output the first physical address to which a first address mapping layout is applied when the physical address is transmitted from the address expander,
wherein the second physical address space is configured to output the second physical address to which a second address mapping layout is applied when the physical address is transmitted from the address expander, and
wherein the first address mapping layout has a row-bank-column address mapping order, and the second address mapping layout has a row-column-bank address mapping order.

11. The PIM system of claim 6,
wherein the memory controller further comprises a command/address generator, the command/address generator being configured to transmit the first physical address and a memory command to the PIM device when the first physical address is transmitted from the first physical address space and configured to transmit the second physical address and a PIM command to the PIM device when the second physical address is transmitted from the second physical address space.

12. The PIM system of claim 1,
further comprising a host including a virtual address space,
wherein the memory management unit includes an address translation table comprising a first page corresponding to the first physical address space and a second page corresponding to the second physical address space, and
wherein the virtual address space includes a structured allocation region configured to distinguish between the first page and the second page.

13. The PIM system of claim 12,
further comprising a direct memory access controller coupled to the host and the memory management unit, the direct memory access controller being configured to change an address mapping layout.

14. The PIM system of claim 13,
wherein the host is configured to transmit a first virtual address, related to a memory operation for the PIM device to perform, to the direct memory access controller and configured to transmit a second virtual address, related to a computation operation for the PIM device to perform, to the memory management unit.

15. The PIM system of claim 14,
wherein the direct memory access controller comprises:
a shuffling unit configured to output an address mapping control signal that designates a first address mapping order, different from a second address mapping order, for the first virtual address; and
a data movement unit configured to perform an address mapping layout transformation on the first virtual address based on the first address mapping order designated by the address mapping control signal received from the shuffling unit, to generate a second virtual address having the first address mapping order, and to transmit the second virtual address to the memory management unit.
